(19) United States
(12) Patent Application Publication
(10) Pub. No.: US 2026/0211720 A1
(43) Pub. Date: Jul. 23, 2026

(54) Method and Apparatus for Processing Task, Device, and Storage Medium

(71) Applicant: Shining 3D Tech Co., Ltd., Hangzhou, Zhejiang (CN)

(72) Inventors: Jinming CHEN, Hangzhou, Zhejiang (CN); Tengfei JIANG, Hangzhou, Zhejiang (CN); Jia YU, Hangzhou, Zhejiang (CN); Shuai LIU, Hangzhou, Zhejiang (CN); Zefeng CHEN, Hangzhou, Zhejiang (CN)

(73) Assignee: Shining 3D Tech Co., Ltd., Hangzhou, Zhejiang (CN)

(21) Appl. No.: 19/142,158

(22) PCT Filed: Nov. 29, 2023
(86) PCT No.: PCT/CN2023/135150

§ 371 Date: Jun. 20, 2025

(30) Foreign Application Priority Data
Dec. 19, 2022 (CN) 202211635279.1

(51) Int. Cl. G06F 9/48; G06F 30/12

(52) U.S. Cl. CPC G06F 9/4856; G06F 30/12

(57) ABSTRACT

Embodiments of the present disclosure provide a method for processing a task and apparatus, and a device. After receiving a target task, a first device may automatically search whether a second device capable of providing a computing service is present in an environment. When the second device capable of providing the computing service is found to be present in the environment, the first device may send verification information to the second device, so that the second device may determine, based on the verification information, whether the second device is able to process the task. In a case that the second device is able to process the task, the two devices may establish a connection, the first device may transfer part or all of the task to the second device for processing, and a processing result is acquired.

### CROSS-REFERENCE TO RELATED APPLICATION

The present application claims priority to Chinese Patent Application No. 202211635279.1, filed on Dec. 19, 2022 and entitled “Method and Apparatus for Processing Task, Device, and Storage Medium”, the disclosure of which is hereby incorporated by reference in its entirety.

### TECHNICAL FIELD

The present disclosure relates to the technical field of communications, and in particular to a method and apparatus for processing a task, a device, and a storage medium.

### BACKGROUND

With the development of technology, some mobile terminals such as a mobile phone and a tablet have strong computational capabilities, and some computation-intensive applications such as Three-Dimensional (3D) scenario reconstruction and rendering and large-scale 3D games may run on these mobile terminals. Taking the 3D scenario reconstruction and rendering as an example, a 3D scanning device may usually rotate 360 degrees around a target scenario to collect images of the target scenario, and then send the images to the mobile terminal. The application on the mobile terminal constructs a 3D point cloud model of the target scenario based on the collected images, performs rasterization processing on the 3D point cloud model, and renders and displays the 3D point cloud model to a user.

### SUMMARY

The embodiments of the present disclosure provides a method and apparatus for processing a task, a device, and a storage medium.

According to a first aspect of embodiments of the present disclosure, a method for processing a task is provided, applicable to a first device, the method including the following operations.

After receiving a target task, it is detected whether a second device capable of providing a computing service is present in a surrounding environment.

In a case that the second device is present, a connection request carrying verification information is sent to the second device.

In a case where the second device determines, based on the verification information, that the second device is able to execute the target task, a connection is established with the second device, and at least part of the target task is sent to the second device, so that the second device processes the received at least part of the target task and returns a processing result.

According to a second aspect of the embodiments of the present disclosure, a method for processing a task is provided, applicable to a second device, the method including the following operations.

A connection request sent by a first device is received. The connection request is sent after the first device receives a target task, and the connection request carries verification information.

A connection is established with the first device in a case where the second device determines, based on the verification information, that the second device is able to execute the target task.

At least part of the target task sent by the first device is received, the received at least part of the target task is processed, and a processing result is returned to the first device.

According to a third aspect of the embodiments of the present disclosure, an apparatus for processing a task is provided, applicable to a first device, the apparatus including a detection component, a verification component, and a sending component.

The detection component is configured to, after receiving a target task, detect whether a second device capable of providing a computing service is present in a surrounding environment.

The verification component is configured to, in a case that the second device is present, send a connection request carrying verification information to the second device.

The sending component is configured to, in a case where the second device determines, based on the verification information, that the second device is able to execute the target task, establish a connection with the second device, and send at least part of the target task to the second device, so that the second device processes the received at least part of the target task and returns a processing result.

According to a fourth aspect of the embodiments of the present disclosure, an apparatus for processing a task is provided, applicable to a second device, the apparatus including a receiving component, a verification component, and a processing component.

The receiving component is configured to receive a connection request sent by a first device. The connection request is sent after the first device receives a target task, and the connection request carries verification information.

The verification component is configured to establish a connection with the first device in a case where the second device determines, based on the verification information, that the second device is able to execute the target task.

The processing component is configured to receive at least part of the target task sent by the first device, process the received at least part of the target task, and return a processing result to the first device.

According to a fifth aspect of the embodiments of the present disclosure, an electronic device is provided. The electronic device includes a processor, a memory, and computer instructions stored in the memory and executable by the processor. The processor may implement the method mentioned in the first aspect above when executing the computer instructions.

According to a sixth aspect of the embodiments of the present disclosure, a computer-readable storage medium is provided, on which computer instructions are stored. The computer instructions are executed to implement the method mentioned in the first aspect above.

In the embodiments of the present disclosure, after receiving the target task, the first device may automatically search whether the second device capable of providing the computing service is present in the environment. When the second device capable of providing the computing service is found to be present in the environment, the first device may send the verification information to the second device, so that the second device may determine, based on the verification information, whether the second device is able to process the task. In a case that the second device is able to process the task, the two devices may establish the connection, the first device may transfer part or all of the task to the second device for processing, and the processing result is acquired.

It is to be understood that the above general description and the following detailed description are only exemplary and explanatory and not intended to limit the present disclosure.

### BRIEF DESCRIPTION OF THE DRAWINGS

The drawings, which are incorporated in and constitute a part of this specification, illustrate embodiments consistent with the present disclosure and, together with the specification, serve to explain the technical solutions of the present disclosure.

FIG. 1 is a schematic diagram of an application scenario according to an embodiment of the present disclosure.

FIG. 2 is a flowchart of a method for processing a task according to an embodiment of the present disclosure.

FIG. 3 is a schematic diagram of an application scenario according to an embodiment of the present disclosure.

FIG. 4 is a schematic diagram of an application scenario according to an embodiment of the present disclosure.

FIG. 5 is a flowchart of a method for processing a task according to an embodiment of the present disclosure.

FIG. 6 is a timing diagram of a method for processing a task according to an embodiment of the present disclosure.

FIG. 7 is a schematic diagram of a logical structure of an apparatus for processing a task according to an embodiment of the present disclosure.

FIG. 8 is a schematic diagram of a logical structure of an apparatus for processing a task according to an embodiment of the present disclosure.

FIG. 9 is a schematic diagram of a logical structure of a device according to an embodiment of the present disclosure.

### DETAILED DESCRIPTION OF THE EMBODIMENTS

Exemplary embodiments will be described in detail herein, examples of which are shown in the drawings. When the following description refers to the drawings, the same numbers in different drawings represent the same or similar elements unless otherwise indicated. The implementations described in the following exemplary embodiments do not represent all implementations consistent with the present disclosure. Instead, they are merely examples of apparatuses and methods consistent with some aspects of the present disclosure as detailed in the appended claims.

Terms used in the present disclosure are only for describing the specific embodiments and are not intended to limit the present disclosure. Singular forms “a/an” and “the” used in the present disclosure and appended claims are also intended to include plural forms unless other meanings are clearly expressed in the context. It is also to be understood that the term “and/or” as used herein means and includes any or all possible combinations of one or more associated listed items. In addition, the term “at least one” herein refers to any one of the plurality or any combination of at least two of the plurality.

It is to be understood that although the terms first, second, third, etc., may be used in the present disclosure to describe various information, these information should not be limited to these terms. These terms are only used to distinguish information of the same type from each other. For example, without departing from the scope of the present disclosure, first information may be referred to as second information, and similarly, the second information may also be referred to as the first information. Depending on the context, the word “if” as used herein may be interpreted as “at” or “when” or “in response to determining”.

In order to enable those skilled in the art to better understand the technical solutions in the embodiments of the present disclosure, and make the purposes, features and advantages of the present disclosure clearer, the technical solutions in the embodiments of the present disclosure will be described below in detail in combination with the drawings.

With the development of technology, mobile terminals such as a mobile phone and a tablet have strong computational capabilities, and some computation-intensive applications (i.e., those with large amount of computation and high computational intensity), such as 3D scenario reconstruction and rendering and large-scale 3D games may run on these mobile terminals. For example, the computational capability of iPad Pro currently equipped with M-series chips is already very strong, comparable to a desktop-level Intel Central Processing Unit (CPU). Therefore, it is possible to run computation-intensive applications on the iPad Pro equipped with the M-series chips.

Taking the 3D scenario reconstruction and rendering as an example, a 3D scanning device may usually rotate 360 degrees around a target scenario to collect images of the target scenario, and then send the images to the mobile terminal. The application on the mobile terminal constructs a 3D point cloud model of the target scenario based on the collected images, performs rasterization processing on the 3D point cloud model, and renders and displays the 3D point cloud model to a user. Since the amount of computation of a 3D reconstruction process is relatively large, even in a case that the current mobile terminal may complete such computing tasks independently, executing such tasks with large amount of computation for a long time may also cause overheating and frequency reduction of a chip on the mobile terminal, resulting in a significant decrease in computing performance.

At present, the commonly used solution is to dissipate heat from the mobile terminal through a radiator. Although this method can avoid overheating and frequency reduction of the chip, since the mobile terminal is placed on the radiator, the mobile terminal is unable to move easily and the portability of the mobile terminal is lost. In addition, due to the need for additional radiators, the problem of overheating of the chip cannot be improved in scenarios without the radiator.

Based on this, the embodiments of the present disclosure provide a method for processing a task, which may be configured to process some computation-intensive tasks. Considering that an environment usually includes a plurality of devices, for example, the user may have a plurality of devices such as the mobile phone, the tablet, and a computer. Therefore, after receiving the computation-intensive tasks, the device may jointly process the tasks with the help of computing resources of other devices in the environment, thereby avoiding overheating of the device chip. For example, a pre-developed application program may be installed in advance in each device, or a pre-developed service may be set, and when running the application program or service, the device that receives the computation-intensive tasks may automatically search whether a device capable of providing a computing service is present in the environment. When the device capable of providing the computing service is found to be present in the environment, verification information may be sent to the second device, so that the device may determine, based on the verification information, whether the device is able to process the task. In a case that the device is able to process the task, the two devices may establish a connection, the device that receives the intensive task may transfer part or all of the task to the device capable of providing the computing service for processing, and a processing result is acquired. The computation-intensive tasks are jointly processed with the help of the computing resources of other devices in the environment, so that overheating of the device may be avoided and task processing efficiency may also be improved.

For the convenience of description, hereinafter, the devices that receive the intensive tasks are collectively referred to as a first device, and the devices capable of providing the computing services for the first device are collectively referred to as a second device. The first device may be the mobile terminal such as the mobile phone or the tablet, and the second device may be the mobile phone, the tablet, the computer, etc. Generally speaking, the computing performance of the second device is not lower than that of the first device.

In order to enable the first device to process the computation-intensive tasks with the help of the computing resources of the second device, self-developed software may be installed on the first device and the second device respectively, or self-developed services may be set in the first device and the second device, so that the first device may automatically detect and discover the surrounding second device, and send the verification information to the second device. After the second device determines, based on the verification information, that the second device may process the task, the first device and the second device establish the connection to complete the transfer and collaborative processing of the tasks.

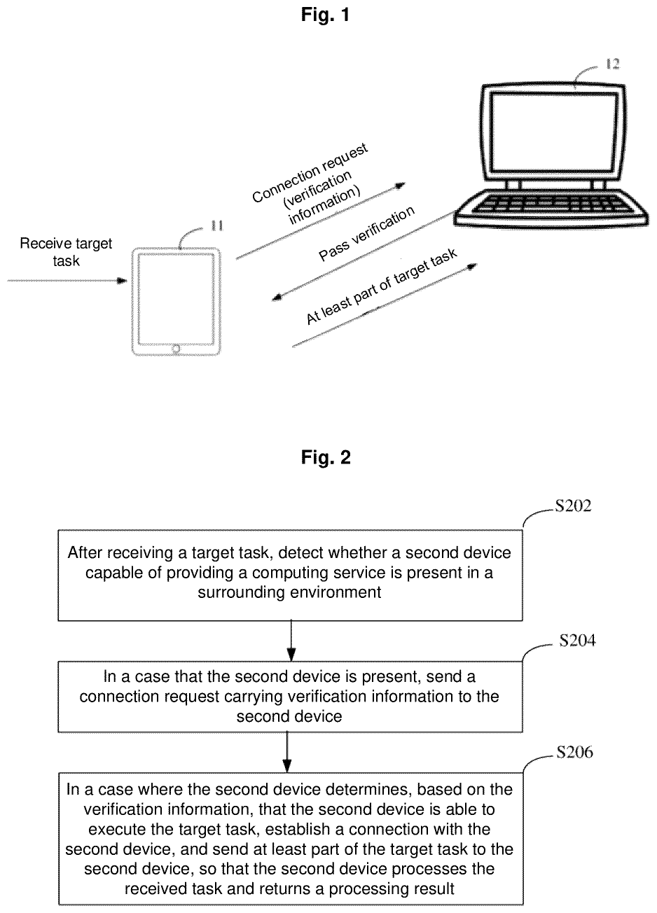

As shown in FIG. 1, it is a schematic diagram of an application scenario of a method for processing a task according to an embodiment of the present disclosure. An environment includes a first device 11 and a second device 12. After receiving a target task, the first device 11 may detect whether the second device 12 is present around, send verification information to the second device 12 in a case that detected, and send the target task to the second device 12 after verification is passed.

Hereinafter, in combination with FIG. 2, the method for processing a task will be described from the processing flow of the first device, and may specifically include the following steps.

At S202, after receiving a target task, it is detected whether a second device capable of providing a computing service is present in a surrounding environment.

In S202, after receiving the target task, the first device may automatically detect whether the second device capable of providing the computing service is present in the surrounding environment. The target task may be some computation-intensive tasks, such as 3D reconstruction tasks in complex scenarios and rendering tasks in 3D game scenarios. Considering that the first device completes these tasks independently and the amount of computation is relatively large, which may cause overheating and frequency reduction of a chip in the first device, the first device may detect whether the second device is present in the surrounding environment after receiving a similar target task. For example, the first device and the second device may achieve Peer-to-Peer (P2P) communication, and after the second device is turned on, the second device may broadcast a message, so that the first device may detect the second device based on the broadcast message. In some scenarios, the first device may automatically detect and communicate with the second device through some services for discovering nearby devices and establishing P2P communication with the devices. For example, taking the first device being an Apple device as an example, the first device may automatically search other nearby Apple devices based on a Multipeer service framework and perform P2P communication with the other nearby Apple devices. Of course, the embodiments of the present disclosure are not limited to the Multipeer service framework, and may also be other service frameworks having similar functions.

At S204, in a case that the second device is present in the surrounding environment, a connection request carrying verification information is sent to the second device.

In S204, in a case that the first device detects that the second device is present in the surrounding environment, the first device may send the connection request to the second device. The connection request may carry the verification information, which may be configured to determine whether the second device is able to process the target task. For example, considering the security of data transmission, the second device may verify the identity of the first device, and establish the connection and assist in processing computing tasks only when the identity of the first device meets a certain condition. Alternatively, considering that the second device may not have the ability to execute the task that the first device wants to transfer to the second device, in a case that the target task is not verified in advance and the target task is received directly from the first device, transmission resources may be wasted, and the overall processing efficiency of the task may be reduced because the second device is unable to process the target task. Therefore, when the first device requests to establish the connection with the second device, the verification information may be carried, so that the second device determines, based on the verification information, whether the second device is able to process the target task.

At S206, in case where the second device determines, based on the verification information, that the second device is able to execute the target task, a connection is established with the second device, and at least part of the target task is sent to the second device, so that the second device processes the received at least part of the target task and returns a processing result.

In S206, after receiving the connection request of the first device, the second device may determine, based on the verification information, whether the second device is able to execute the target task. In a case that the second device is able to execute the target task, the second device agrees to the connection request of the first device, so that the first device may establish the connection with the second device, and then the first device may send part or all of the target task to the second device through the established connection, so that the second device may process the received task and return the processing result. The first device and the second device may establish a P2P communication connection, for example, P2P communication (referred to as P2P Internet technology) may be achieved through a Multipeer framework service or a service having similar functions, or in a case that the two devices are in the same local area network, the communication connection may also be established through a local area network.

In some embodiments, the verification information may include identity information of the first device, and after determining that the identity information of the first device meets a preset condition, the second device determines that the second device is able to execute the target task sent by the first device, and establishes the connection therewith. For example, after detecting the second device, the first device may send a token identifying the identity to the second device (the token is assigned by a developer), after receiving the token, the second device may verify the validity of the token, establish the connection with the first device in a case that the token is valid, and otherwise refuse the connection request of the first device. By verifying the identity of the first device, the computing resources of the second device may be avoided from being maliciously occupied, and the security of data transmission may also be ensured.

In some embodiments, considering that the target task may have a plurality of types of tasks, different types of target tasks have different amount of computations and different performance requirements for processing devices. Therefore, different second devices are able to process different types of tasks. In order to avoid the second device from discovering that hardware resources thereof are unable to support the target task after receiving the target task, resulting in waste of transmission resources and reduction of task processing efficiency, the verification information may also include a task type of the target task, and after receiving the verification information, the second device may determine whether the task type of the target task matches a task type that the second device is capable of processing, establish the connection with the first device in a case that matched, and receive the task transferred by the first device.

In some embodiments, the first device and the second device may communicate in a P2P manner, and in general, a transmission bandwidth supportable during the P2P communication has a certain upper limit. For example, taking the Multipeer service framework as an example, the maximum bandwidth supportable by the two devices that achieve P2P communication based on the Multipeer service framework is 5 GB/s. In order to avoid the problem that the transmission bandwidth between the two devices is unable to support the data transmission of the target task, the verification information may also include a transmission bandwidth required by executing the target task. After receiving the verification information, the second device may determine whether the transmission bandwidth required by executing the target task exceeds a target bandwidth. The target bandwidth is the maximum bandwidth supportable during P2P communication between the two devices, and in a case that the transmission bandwidth does not exceed the target bandwidth, the second device agrees to establish the connection with the first device.

In addition, considering that in some scenarios where the first device and the second device are located in the same local area network, the two may also transmit data through the local area network. Since the local area network may generally support a larger bandwidth, in a case that it is determined that the transmission bandwidth required by executing the target task exceeds the above target bandwidth, it may be further determined whether the first device and the second device are located in the same local area network, and in a case that the two are located in the same local area network, it may also be considered that the second device is able to process the target task and establish the connection with the first device.

Of course, when the verification information is actually set, the verification information may include one or more of the identity information of the first device, the task type of the target task, and the transmission bandwidth required by executing the target task, and when verifying whether the second device is able to execute the target task, the determination may also be made in combination with the one or more of the verification information, and may be specifically set based on actual needs. For example, in some scenarios, there is only one type of the target task by default, so that there is no need to verify the type of the target task, or the transmission bandwidth required by executing the target task is not higher than the maximum bandwidth supported during P2P communication between the two devices by default, so that there is no need to verify the bandwidth.

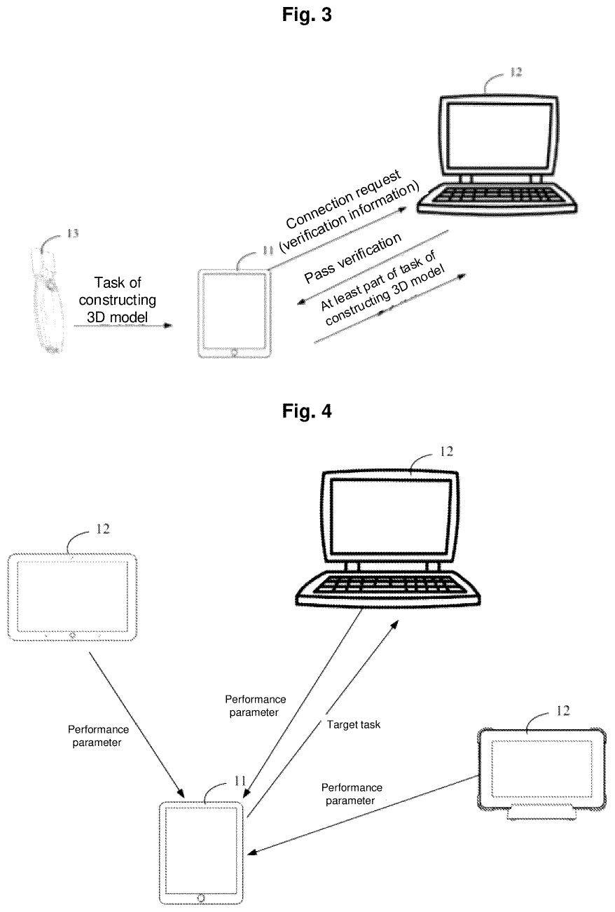

In some embodiments, as shown in FIG. 3, the first device 11 may be in communication connection with a 3D scanning device 13, and the target task may be a task of constructing and displaying a 3D model using data collected by the 3D scanning device 13. At present, there are various types of 3D scanning devices, which may scan a target scenario, collect image data or point cloud data in the target scenario, and construct a 3D model of the target scenario based on the image data or data. Since a 3D reconstruction process involves a relatively large amount of computation, it is necessary to jointly complete the task with the help of the computing resources of other devices. Considering that there are many types of 3D scanning devices, such as an oral scanning device, an industrial scanning device, and a professional scanning device, these scanning devices collect different types of data (for example, images or point clouds), with different amount of data (for example, different resolutions and frame rates), and the amount of computation required to construct the 3D models using the data collected by these devices also varies. For example, the oral scanning device collects oral image data, while the industrial scanning device usually collects laser point cloud data. Compared with the industrial scanning device and the professional scanning device, the oral scanning device collects a relatively small amount of data, and the amount of computation required for 3D reconstruction is also relatively small.

It can be seen that for the data collected by different types of 3D scanning devices, the performance requirements for processing devices are also different during 3D reconstruction. Therefore, for the task of constructing the 3D model using the data collected by different types of 3D scanning devices, different task types may be set, so that a suitable second device may be selected based on the task type.

In addition, in the process of constructing the 3D model using the data collected by the 3D scanning device, the 3D reconstruction process has the largest amount of computation, and it is usually necessary to send this part of the processing task to the second device. It is considered that a large amount of processing data needs to be sent when this part of the processing task is sent to the second device, for example, a large amount of image data or point cloud data needs to be transmitted to construct the 3D point cloud model. Therefore, in this scenario, the first device and the second device may perform P2P communication, and the P2P communication may provide a larger transmission bandwidth than communication through the Internet, which is more suitable for such a task transfer scenario that requires transmission of a large amount of data.

In some embodiments, as shown in FIG. 4, a plurality of second devices may be present in the surrounding environment of the first device. For example, when the user uses his mobile phone to process the target task, a plurality of devices such as the computer and the tablet of the user are placed nearby, and these devices may provide computing services. In order to improve the task processing efficiency, the device with the best or better computing performance at present may be selected to assist in the processing of the target task. For example, in a case that the first device detects that the plurality of second devices are present in the surrounding environment, and the plurality of second devices are able to process the target task, the first device may notify each second device of feedback of current performance parameters. The performance parameters may characterize a current computational capability of the device. For example, the performance parameters may be the current occupancy of hardware resources of the device, the hardware performance parameters of each device, etc. Then, a target second device having the best performance and the strongest computational capability may be selected from the plurality of second devices based on the performance parameters, or a target second device having the computing performance meeting a certain condition may be selected, and part or all of the target processing task may be transferred to the target second device for processing by the target second device.

In some embodiments, the target task may be split into a plurality of subtasks, and one or more of the second devices may be detected in the surrounding environment, that is, the first device and the one or more of the second devices may form a distributed computing system. After the first device establishes the connection with the one or more of the second devices, the first device acquires the respective performance parameters of the first device and each of the second devices. The performance parameters may characterize the current computational capability of the device. For example, the performance parameters may be the current occupancy of hardware resources of the device, the hardware performance parameters of each device, etc. Then, allocation manners of the plurality of subtasks between the first device and the one or more of the second devices may be determined based on the respective performance parameters, and at least part of the plurality of subtasks may be respectively sent to the second device based on the allocation manners. By dynamically adjusting the allocation manners of the subtasks of the target task according to the current processing capabilities of the first device and the one or more of the second devices, an optimal allocation strategy may be determined, thereby improving the task processing efficiency. At the same time, the target task is processed with the help of the distributed computing system formed by one or more surrounding second devices and the first device, which may improve the task processing efficiency.

For example, in some embodiments, the target task may be a task of constructing and displaying the 3D model using the images collected by the 3D scanning device. Taking one second device as an example, the target task may be split into the following subtasks of: (1) performing 3D reconstruction using the images to obtain the 3D point cloud model; (2) performing encapsulation processing on the 3D point cloud model; (3) performing rasterization processing on the point cloud model; and (4) rendering and displaying the three-dimensional model after rasterization processing. Among the above four subtasks, the subtask (1) has the largest amount of computation and relatively high requirements for the computational capability. Therefore, when the first device transfers the target task to the second device for processing, in a case that it is determined based on the performance parameters of the second device that the current computational capability of the second device are relatively strong, for example, the current hardware resources of the second device are only slightly occupied, the subtasks (1) to (3) may be transferred to the second device for execution, and the remaining subtasks are executed by the first device. In a case that it is determined based on the performance parameters of the second device that the current computational capability of the second device are weak, for example, the current hardware resources of the second device are largely occupied, only the subtask (1) may be transferred to the second device for execution.

Of course, for scenarios where the plurality of second devices are present, the above subtasks are further allocated based on the performance parameters of the first device and each of the second devices, for example, a plurality of frames of images may be divided into a plurality of groups, and one second device may be used to perform 3D reconstruction on one group of images to obtain a part of a 3D point cloud. Of course, other allocation manners may also be adopted, and specifically, the task allocation situation may be flexibly set based on the characteristics of the distributed computing system, which is not limited in the embodiments of the present disclosure.

In some embodiments, in a case that no second device is present in the surrounding environment, that is, the first device is unable to complete the target task with the help of other devices, in this case, in order to avoid overheating of the first device, degraded processing may be performed on the target task to reduce the amount of computation of the target task.

For example, in some embodiments, the first device is in communication with the 3D scanning device, and the target task may be the task of constructing and displaying the 3D model using the data collected by the 3D scanning device. For example, the first device continuously receives data in the target scenario collected by the 3D scanning device, and constructs the 3D model based on the collected data. The degraded processing may be performed on the target task in the following two manners.

Manner (1): the 3D scanning device is notified to reduce a data collection speed. For example, taking the image in the target scenario collected by the 3D scanning device as an example, the 3D scanning device may be notified to reduce a scanning speed (the number of images taken per second), thereby reducing the frame rate of the collected image, and further reducing the processing pressure of the first device.

Manner (2): only some of the subtasks of the target task are executed. The some of the subtasks at least include constructing the 3D point cloud model based on the data collected by the 3D scanning device. In order to avoid overheating of the first device, the first device may process only some of the subtasks to be processed at present in the target task, and the remaining subtasks may be executed by the remaining devices, or may be subsequently executed by this device (offline processing). Taking the image in the target scenario collected by the 3D scanning device as an example, considering that after the first device acquires the image from the 3D scanning device, the step of constructing the 3D point cloud model using the image is necessary, and other steps such as encapsulation may be executed later, so that the necessary step may be executed first. That is, during the scanning process of the user, the first device may first display the ybencapsulated 3D point cloud model to meet the basic requirement of the user to see the scanning progress while scanning. After the user completes the scanning, the first device may execute encapsulation and other steps to obtain a more complete and accurate 3D model to meet the requirement of the user for the accuracy of the 3D model.

In some embodiments, the first device and the second device are both iOS-based devices, for example, the first device is an ipad and the second device is a Mac, and the first device and the second device may establish P2P communication through the Multipeer service framework.

In some embodiments, the first device and the second device may be iOS systems, Android systems, windows systems, or Linux systems, and the first device and the second device may establish communication through Bluetooth mesh (Bluetooth mesh), Near Field Communication (NFC), an automatic discovery service, an mqtt instant messaging protocol, or a Zigbee wireless communication protocol.

For scenarios where the target task is the 3D reconstruction task, the amount of data that the first device needs to send to the second device is relatively large. Through short-range communication methods such as Bluetooth and NFC, the two devices may directly transmit data. Compared with transmission through the Internet, this communication method does not require the transfer of a router and other devices, and is less susceptible to the impact of the network bandwidth, which may ensure the stability of data transmission and is more suitable for the scenarios of the 3D reconstruction task.

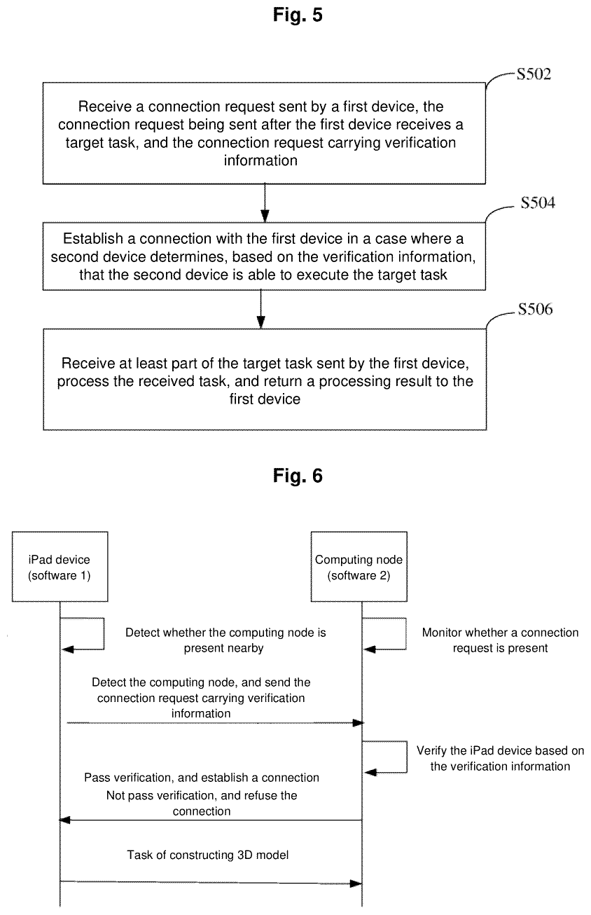

As shown in FIG. 5, it is a schematic diagram of a processing flow of a second device. The processing flow may specifically include the following steps.

At S502, a connection request sent by a first device is received. The connection request is sent after the first device receives a target task, and the connection request carries verification information.

At S504, a connection is established with the first device in a case where the second device determines, based on the verification information, that the second device is able to execute the target task.

At S506, at least part of the target task sent by the first device is received, the received at least part of the target task is processed, and a processing result is returned to the first device.

In some embodiments, the operation of determining, based on the verification information, that the second device is able to execute the target task includes the following operations.

The verification information includes identity information of the first device, the identity information meeting a preset condition.

The verification information includes a task type of the target task, the task type matching a task type that the second device is capable of processing.

The verification information includes a transmission bandwidth required by executing the target task, the transmission bandwidth being not higher than a target bandwidth.

The verification information includes a transmission bandwidth required by executing the target task, the transmission bandwidth being higher than the target bandwidth, and the first device and the second device being located in the same local area network.

The target bandwidth is a maximum bandwidth supportable during P2P communication between the first device and the second device.

In some embodiments, the first device is in communication connection with a 3D scanning device, and the target task is to construct and display a 3D model using data collected by the 3D scanning device. Different types of 3D scanning devices correspond to different task types of the target tasks.

In some embodiments, in a case of determining, based on the verification information, that the second device is unable to execute the target task, the establishment of the connection with the first device is refused.

Of course, in some scenarios, considering the better performance of the second device, computing services may be provided for a plurality of first devices at the same time. Therefore, the second device may also establish the connections with the plurality of first devices, receive the tasks sent by the plurality of first devices, process the tasks, and return the tasks to each of the first devices.

The specific implementation details of the second device when executing the above method for processing a task may refer to the description in the above embodiment, which will not be elaborated herein.

In order to further introduce the method for processing a task provided by the embodiments of the present disclosure, the method for processing a task will be explained below in combination with a specific embodiment.

In the field of oral treatment, a doctor may use an oral scanning device to communicate with an ipad device of the doctor. The oral scanning device may send collected images of an oral cavity of a patient to the ipad device, and a designated application on the ipad device constructs and displays a 3D model of the oral cavity using image data. Due to the relatively large amount of computation of a 3D reconstruction task, although the computational capability of iPad Pro currently equipped with M series chips is already very strong, the above 3D reconstruction task may be independently completed. However, in a case that the processing time is relatively long, overheating and frequency reduction of the chip of the ipad device are easily caused, which affects the processing performance.

Considering that P2P communication between iOS devices can be achieved through a Multipeer service framework, other nearby Apple devices (such as Mac) may be used as computing nodes to jointly complete the task of constructing the 3D model.

For example, as shown in FIG. 6, pre-developed software 1 and software 2 may be installed on the ipad device and the computing node, respectively. After the above software 1 runs on the ipad device, in a case that the ipad device receives the task of constructing the 3D model using the images, the ipad device may detect whether the computing node is present nearby using a Multipeer service, and in a case that the computing node is detected nearby, the ipad device may send a connection request to the computing node, and the connection request carries verification information. After the above software 2 runs on the computing node, the computing node may monitor the connection request sent by the ipad device using the Multipeer service. In a case that the computing node monitors the connection request, the computing node verifies the ipad device based on the verification information carried in the connection request. In a case that the verification is passed, the computing node establishes the connection with the ipad device, receives a processing task sent by the ipad device, and returns the task to the ipad device after processing. In a case that the verification fails, the establishment of the connection is refused.

The computing node may verify the ipad device in the following three aspects.

1. Permission verification. That is, the ipad device may pass an assigned token (assigned by a developer) to the computing node. The computing node may verify whether the token is valid. In a case that the token is valid, the connection is continued. In a case that the token is invalid, the connection is refused, thereby ensuring that the computing node is not maliciously occupied.

2. Computing service name and version. Since different computing nodes are able to provide different types of computing services, for example, the 3D scanning device includes an oral scanning device, a professional scanning device, an industrial scanning device, etc., and when 3D reconstruction is performed on data collected by different scanning devices, the performance requirements for the computing nodes are also different. Therefore, the verification information may include a name and version information of the computing service currently required by the ipad device, so that the computing node may determine whether the computing node is able to execute the computing task.

3. Expected bandwidth size. Different computing services require different bandwidths. A maximum bandwidth provided by the Multipeer service framework is about 5 GB/s. In a case that the bandwidth required by executing the computing task is less than the maximum bandwidth, the verification is passed. In a case that a higher bandwidth is required, local area network technologies such as WiFi and Ethernet are required. Local area network transmission requires both the iPad and the computing node to be connected to the same local area network. In a case that the two are not currently connected to the local area network or the connected local area networks are different, the verification fails.

The ipad device may determine allocation manners of the computing tasks based on the computing node and the current computational capability of the ipad device, for example, when the current hardware processing resources of the computing node are largely occupied, the ipad device may only allocate the task of constructing the 3D point cloud model based on the image data to the computing node for processing, and when most of the current hardware processing resources of the computing node are idle, the tasks of constructing the 3D point cloud model based on the image data, and performing encapsulation and rasterization processing on the 3D point cloud model may be allocated to the computing node.

Of course, in a case that detecting a plurality of computing nodes, the ipad device may select the computing node with the strongest computational capability at present and assign the computing task to this node.

In addition, in a case that the current ipad device does not detect the computing node, the oral scanning device may be notified to reduce an image collection speed, or the ipad device may only execute the task of constructing a 3D point cloud model using the image data, and no longer perform the tasks of encapsulation and rasterization processing of the 3D point cloud model, so as to reduce the amount of computation.

It is not difficult to understand that the solutions described in the above embodiments may be combined without conflict, which will not be exemplified one by one in the embodiments of the present disclosure.

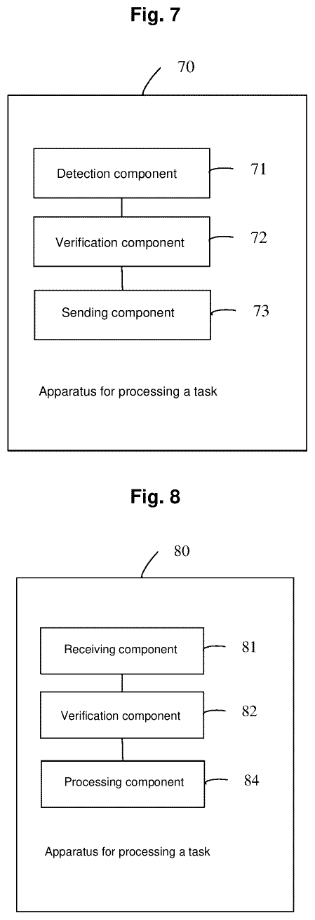

Accordingly, the embodiments of the present disclosure further provide an apparatus for processing a task, applicable to a first device. As shown in FIG. 7, the apparatus 70 includes a detection component, a verification component, and a sending component.

The detection component 71 is configured to, after receiving a target task, detect whether a second device capable of providing a computing service is present in a surrounding environment.

The verification component 72 is configured to, in a case that the second device is present, send a connection request carrying verification information to the second device.

The sending component 73 is configured to, in a case where the second device determines, based on the verification information, that the second device is able to execute the target task, establish a connection with the second device, and send at least part of the target task to the second device, so that the second device processes the received at least part of the target task and returns a processing result.

The specific steps of the above apparatus executing the method for processing a task may refer to the description in the above method embodiment, which will not be elaborated herein.

Accordingly, the embodiments of the present disclosure further provide another apparatus for processing a task, applicable to a second device. As shown in FIG. 8, the apparatus 80 includes a receiving component, a verification component, and a processing component.

The receiving component 81 is configured to receive a connection request sent by a first device. The connection request is sent after the first device receives a target task, and the connection request carries verification information.

The verification component 82 is configured to establish a connection with the first device in a case where the second device determines, based on the verification information, that the second device is able to execute the target task.

The processing component 83 is configured to receive at least part of the target task sent by the first device, process the received at least part of the target task, and return a processing result to the first device.

The specific steps of the above apparatus executing the method for processing a task may refer to the description in the above method embodiment, which will not be elaborated herein.

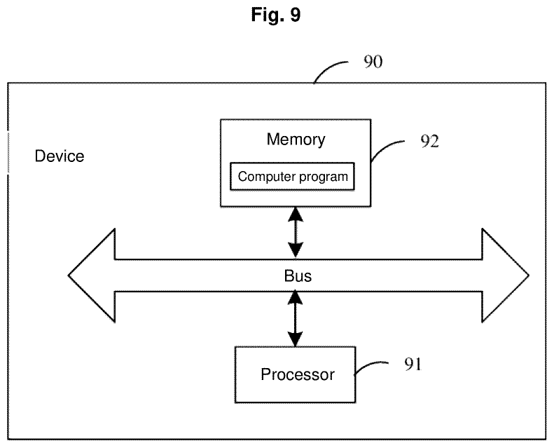

Further, the embodiments of the present disclosure further provides an apparatus, as shown in FIG. 9, the apparatus includes a processor 91, a memory 92, and computer instructions stored in the memory 92 and executable by the processor 91. The processor 91 implements any method in the above embodiments when executing the computer instructions.

The embodiments of the present disclosure further provide a computer-readable storage medium, on which a computer program is stored. The program, when executed by a processor, implements the method of any of the abovementioned embodiments.

The computer-readable medium includes volatile and non-volatile, removable and non-removable media implemented in any method or technology for storage of information. The information may be computer-readable instructions, data structures, program components, or other data. Examples of the computer storage media include, but are not limited to, a Phase-Change Random Access Memory (PRAM), a Static Random Access Memory (SRAM), a Dynamic Random Access Memory (DRAM), other types of Random Access Memory (RAM), Read-Only Memory (ROM), Electrically Erasable Programmable ROM (EEPROM), flash memory or other memory technologies, CD-ROM, Digital Video Disks (DVDs) or other optical storage, magnetic cassette tapes, tape disk storage or other magnetic storage devices, or any other non-transmission medium which can be used to store the information that can be accessed by the computing device. As defined herein, the computer-readable medium does not include transitory media, such as modulated data signals and carriers.

Through the above description of implementations, those skilled in the art may clearly know that the embodiments of the present disclosure may be implemented by means of software plus a necessary common hardware platform. Based on such understanding, the technical solution of the embodiments of the present disclosure substantially or the part making a contribution to the conventional art can be embodied in the form of a software product. The computer software product may be stored in a storage medium such as an ROM/RAM, a magnetic disk, and a compact disc, including a number of instructions for causing a computer device (which may be a personnel computer, a server, or a network device, etc.) to perform the methods of each embodiment of the embodiments of the present disclosure or some parts of the embodiments.

The systems, apparatuses, components, or units described in the above embodiments may be implemented by a computer chip or entity, or by a product having a certain function. A typical implementation device is a computer, which may be in the form of a personal computer, a laptop computer, a cellular phone, a camera phone, a smart phone, a personal digital assistant, a media player, a navigation device, an email transceiver device, a game console, a tablet computer, a wearable device, or a combination of any of these devices.

The various embodiments in the present specification are described in a progressive manner, the same similar parts between the various embodiments can be referred to each other, and each embodiment focuses on differences from other embodiments. In particular, for the apparatus embodiments, since it is basically similar to the method embodiment, the description is relatively simple, and the relevant parts can be referred to the partial description of the method embodiment. The apparatus embodiments described above are merely illustrative, and components described as separate parts may or may not be physically separated, and the functions of each component may be implemented in the same or more software and/or hardware when implementing the embodiments of the present disclosure. Part or all of the components may also be selected according to actual requirements to achieve the purposes of the solutions of this embodiment. Those of ordinary skill in the art may understand and implement without creative efforts.

The above are merely preferred implementations of the embodiments of the present disclosure, and it is to be noted that those of ordinary skill in the art may also make several improvements and refinements without departing from the principle of the embodiments of the present disclosure, and it should be considered that these improvements and refinements shall all fall within the scope of protection of the present disclosure.

### Industrial Applicability

The present disclosure relates to the technical field of communications, and specifically discloses a method for processing a task, which includes that: after receiving a target task, a first device may automatically search whether a second device capable of providing a computing service is present in an environment. When the second device capable of providing the computing service is found to be present in the environment, the first device may send verification information to the second device, so that the second device may determine, based on the verification information, whether the second device is able to process the task. In a case that the second device is able to process the task, the two devices may establish a connection, the first device may transfer part or all of the task to the second device for processing, and a processing result is acquired. Computation-intensive tasks are jointly processed with the help of computing resources of other devices in the environment, so that overheating of the device may be avoided and task processing efficiency may also be improved. Therefore, the present disclosure has industrial applicability.

1. A method for processing a task, applicable to a first device, the method comprising:
after receiving a target task, detecting whether a second device capable of providing a computing service is present in a surrounding environment;
in a case that the second device is present, sending a connection request carrying verification information to the second device; and
in a case where the second device determines, based on the verification information, that the second device is able to execute the target task, establishing a connection with the second device, and sending at least part of the target task to the second device, so that the second device processes received at least part of the target task and returns a processing result.

2. The method as claimed in claim 1, determining that the second device is able to execute the target task in a case where the verification information conforms to one or more of the following conditions:
in a case that the verification information comprises identity information of the first device, the identity information meeting a preset condition;
in a case that the verification information comprises a task type of the target task, the task type matching a task type that the second device is capable of processing;
in a case that the verification information comprises a transmission bandwidth required by executing the target task, the transmission bandwidth being not higher than a target bandwidth; and
in a case that the verification information comprises a transmission bandwidth required by executing the target task, the transmission bandwidth being higher than the target bandwidth, and the first device and the second device being located in the same local area network;
wherein the target bandwidth is a maximum bandwidth supportable during Peer-to-Peer (P2P) communication between the first device and the second device.

3. The method as claimed in claim 2, wherein the first device is in communication connection with a Three-Dimensional (3D) scanning device, and the target task is to construct and display a 3D model using data collected by the 3D scanning device, wherein different types of 3D scanning devices correspond to different task types of the target tasks.

4. The method as claimed in claim 1, wherein the method further comprises:
in a case that the plurality of second devices are present in the surrounding environment, acquiring respective performance parameters of the plurality of second devices, the performance parameters being configured to characterize a current computational capability of each of the second devices; and
selecting a target second device from the plurality of second devices based on the performance parameters, and sending at least part of the target task to the target second device.

5. The method as claimed in claim 1, wherein the target task comprises a plurality of subtasks, the number of the second devices detected from the surrounding environment is one or more, and the sending at least part of the target task to the second device comprises:
acquiring respective performance parameters of the first device and one or more of the second devices, the performance parameters being configured to characterize a current computational capability of the first device and a current computational capability of each of the second devices;
determining, based on the performance parameters, allocation manners of the plurality of subtasks between the first device and one or more of the second devices; and
respectively sending at least part of the plurality of subtasks to one or more of the second devices based on the allocation manners.

6. The method as claimed in claim 1, wherein in a case that no second device is present in the surrounding environment, performing degraded processing on the target task to reduce the amount of computation of the target task.

7. The method as claimed in claim 6, wherein the first device is in communication connection with the 3D scanning device, and the target task is to construct and display the 3D model using the data collected by the 3D scanning device, wherein the performing degraded processing on the target task comprises:
notifying the 3D scanning device to reduce a data collection speed; and/or
executing only some of the subtasks in the target task, wherein the some of the subtasks at least comprise constructing a 3D point cloud model based on the data collected by the 3D scanning device.

8. The method as claimed in claim 1, wherein the first device and the second device are both iOS-based devices, and the first device and the second device achieve P2P communication through a Multipeer service framework.

9. A method for processing a task, applicable to a second device, the method comprising:
receiving a connection request sent by a first device, the connection request being sent after the first device receives a target task, and the connection request carrying verification information;
establishing a connection with the first device in a case where the second device determines, based on the verification information, that the second device is able to execute the target task; and
receiving at least part of the target task sent by the first device, processing the received at least part of the target task, and returning a processing result to the first device.

10. The method as claimed in claim 9, wherein the determining, based on the verification information, that the second device is able to execute the target task comprises:
in a case that the verification information comprises identity information of the first device, the identity information meeting a preset condition;
in a case that the verification information comprises a task type of the target task, the task type matching a task type that the second device is capable of processing;
in a case that the verification information comprises a transmission bandwidth required by executing the target task, the transmission bandwidth being not higher than a target bandwidth; and
in a case that the verification information comprises a transmission bandwidth required by executing the target task, the transmission bandwidth being higher than the target bandwidth, and the first device and the second device being located in the same local area network;
wherein the target bandwidth is a maximum bandwidth supportable when the first device and the second device perform Peer-to-Peer (P2P) communication.

11. The method as claimed in claim 10, wherein the first device is in communication connection with a Three-Dimensional (3D) scanning device, and the target task is to construct and display a 3D model using data collected by the 3D scanning device, wherein different types of 3D scanning devices correspond to different task types of the target tasks.

12. The method as claimed in claim 9, wherein in a case where of determining, based on the verification information, that the second device is unable to execute the target task, the establishment of the connection with the first device is refused.

13. (canceled)

14. (canceled)

15. An electronic device, comprising a processor, a memory, and computer instructions stored in the memory and executed by the processor to:
after receiving a target task, detect whether a second device capable of providing a computing service is present in a surrounding environment;
in a case that the second device is present, send a connection request carrying verification information to the second device; and
in a case where the second device determines, based on the verification information, that the second device is able to execute the target task, establish a connection with the second device, and send at least part of the target task to the second device, so that the second device processes received at least part of the target task and returns a processing result.

16. A non-transitory computer-readable storage medium, on which a computer program is stored, and the computer program, when executed by a processor, implementing the method as claimed in claim 1.

17. The method as claimed in claim 1, the detecting whether the second device capable of providing the computing service is present in the surrounding environment comprises:
detecting the second device based on a broadcast message broadcasted by the second device.

18. The method as claimed in claim 7, wherein the 3D scanning device comprises: an oral scanning device, the 3D model comprises: a 3D model of the oral cavity, the data collected by the 3D scanning device comprises: image data of the oral cavity.

19. The method as claimed in claim 18, the executing only some of the subtasks in the target task comprises:
executing only the task of constructing a 3D point cloud model using the image data of the oral cavity, and no longer perform the tasks of encapsulation and rasterization processing of the 3D model of the oral cavity.

20. The method as claimed in claim 9, wherein the method further comprises:
broadcasting a broadcast message to make the first device detect the second device based on the broadcast message.

21. The electronic device as claimed in claim 15, wherein the processor is further configured to determine that the second device is able to execute the target task in a case where the verification information conforms to one or more of the following conditions:
in a case that the verification information comprises identity information of the first device, the identity information meeting a preset condition;
in a case that the verification information comprises a task type of the target task, the task type matching a task type that the second device is capable of processing;
in a case that the verification information comprises a transmission bandwidth required by executing the target task, the transmission bandwidth being not higher than a target bandwidth; and
in a case that the verification information comprises a transmission bandwidth required by executing the target task, the transmission bandwidth being higher than the target bandwidth, and the first device and the second device being located in the same local area network;
wherein the target bandwidth is a maximum bandwidth supportable during Peer-to-Peer (P2P) communication between the first device and the second device.

22. The electronic device as claimed in claim 15, wherein the processor is further configured to:
in a case that the plurality of second devices are present in the surrounding environment, acquire respective performance parameters of the plurality of second devices, the performance parameters is configured to characterize a current computational capability of each of the second devices; and
select a target second device from the plurality of second devices based on the performance parameters, and send at least part of the target task to the target second device.
